(19) United States
(12) Patent Application Publication
(10) Pub. No.: US 2025/0285115 A1
(43) Pub. Date: Sep. 11, 2025

(54) AUTHENTICATION BASED ON MULTIPLE LOCATIONS

(71) Applicant: Capital One Services, LLC, McLean, VA (US)

(72) Inventors: Mohamed SECK, Aubrey, TX (US); Rekha SIVAKOLUNDHU, Frisco, TX (US); Gayatri VISHNUBHOTLA, Plano, TX (US)

(21) Appl. No.: 18/597,507

(22) Filed: Mar. 6, 2024

(51) Int. Cl. G06Q 20/40

(52) U.S. Cl. CPC G06Q 20/4015; G06Q 20/4016; G06Q 20/409

(57) ABSTRACT

In some implementations, a user device may receive, from an authentication system, a first request for a location associated with the user device. The user device may transmit, to the authentication system, an indication of the location associated with the user device, in response to the first request. The user device may receive, from the authentication system, a second request for a location associated with a physical card. The user device may transmit a sequence, using short-range electromagnetic waves, to the physical card. The user device may monitor for a response from the physical card to determine the location associated with the physical card. The user device may transmit, to the authentication system, an indication of the location associated with the physical card, in response to the second request.

### BACKGROUND

Many accounts (e.g., bank accounts or gift card accounts, among other examples) are associated with physical cards. Unfortunately, such accounts are susceptible to fraud, both when account information is stolen electronically and when the physical cards are stolen.

### SUMMARY

Some implementations described herein relate to a system for authentication based on multiple locations. The system may include one or more memories and one or more processors communicatively coupled to the one or more memories. The one or more processors may be configured to receive a request to perform an action associated with an account. The one or more processors may be configured to determine a location associated with the request. The one or more processors may be configured to transmit a first location request for a location associated with a user device that is connected to the account. The one or more processors may be configured to receive, in response to the first location request, an indication of the location associated with the user device. The one or more processors may be configured to transmit a second location request for a location associated with a physical card that is connected to the account. The one or more processors may be configured to receive, in response to the second location request, an indication of the location associated with the physical card. The one or more processors may be configured to selectively perform the action based on the location associated with the request, the location associated with the user device, and the location associated with the physical card.

Some implementations described herein relate to a method of authentication based on multiple locations. The method may include receiving, at a user device and from an authentication system, a first request for a location associated with the user device. The method may include transmitting, to the authentication system and from the user device, an indication of the location associated with the user device, in response to the first request. The method may include receiving, at the user device and from the authentication system, a second request for a location associated with a physical card. The method may include transmitting a sequence, using short-range electromagnetic waves, from the user device and to the physical card. The method may include monitoring, at the user device, for a response from the physical card to determine the location associated with the physical card. The method may include transmitting, to the authentication system and from the user device, an indication of the location associated with the physical card, in response to the second request.

Some implementations described herein relate to a non-transitory computer-readable medium that stores a set of instructions for authentication based on multiple locations. The set of instructions, when executed by one or more processors of a device, may cause the device to receive a request to perform an action associated with an account. The set of instructions, when executed by one or more processors of the device, may cause the device to determine a location associated with the request. The set of instructions, when executed by one or more processors of the device, may cause the device to transmit a first location request for a location associated with a user device that is connected to the account. The set of instructions, when executed by one or more processors of the device, may cause the device to receive, in response to the first location request, an indication of the location associated with the user device. The set of instructions, when executed by one or more processors of the device, may cause the device to transmit a second location request for a location associated with a physical card that is connected to the account. The set of instructions, when executed by one or more processors of the device, may cause the device to receive, in response to the second location request, an indication of the location associated with the physical card. The set of instructions, when executed by one or more processors of the device, may cause the device to transmit a request for confirmation based on the location associated with the physical card failing to satisfy a condition. The set of instructions, when executed by one or more processors of the device, may cause the device to receive a response to the request for confirmation. The set of instructions, when executed by one or more processors of the device, may cause the device to selectively perform the action based on the response.

### BRIEF DESCRIPTION OF THE DRAWINGS

FIGS. 1A-1D are diagrams of an example implementation relating to authentication based on multiple locations, in accordance with some embodiments of the present disclosure.

FIGS. 2A-2B are diagrams of an example implementation relating to overriding authentication based on multiple locations, in accordance with some embodiments of the present disclosure.

FIGS. 3A-3B are diagrams of example physical cards, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of one or more devices of FIG. 4, in accordance with some embodiments of the present disclosure.

FIGS. 6-7 are flowcharts of example processes relating to authentication based on multiple locations, in accordance with some embodiments of the present disclosure.

### DETAILED DESCRIPTION

The following detailed description of example implementations refers to the accompanying drawings. The same reference numbers in different drawings may identify the same or similar elements.

Many accounts (e.g., bank accounts or gift card accounts, among other examples) are associated with physical cards. Unfortunately, such accounts are susceptible to fraud, both when account information is stolen electronically and when the physical cards are stolen. When stolen account information is used to request performance of a transaction, power and processing resources are wasted in processing the transaction that a user of the account did not request. Additionally, the user may wish to undo the transaction once the user discovers the fraud. However, undoing the transaction will consume additional power and processing resources.

In order to reduce fraud from account information being stolen electronically, algorithms may be deployed that increase scrutiny for transactions when physical cards are not present. However, such algorithms inadvertently increase likelihood of successful fraud when the physical cards are stolen because these algorithms tend to identify transactions as valid when the physical cards are present at point-of-sale (POS). As a result, computing resources are wasted in undoing fraudulent transactions performed based on stolen physical cards.

Some implementations described herein enable an authentication system to verify that a physical card (associated with an account) is near a location associated with a request before performing an action indicated by the request (using the account). As a result, chances of fraud based on stealing the physical card are reduced, improves security. Additionally, power and processing resources are conserved that otherwise would have been wasted in performing an action not authorized by a user (of the account) and in undoing the action later (e.g., after the fraud is discovered).

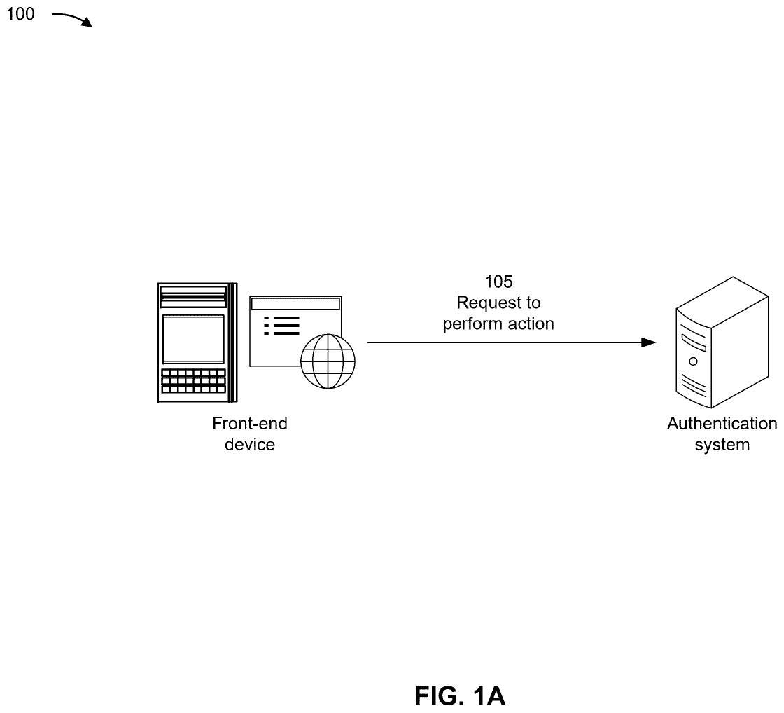

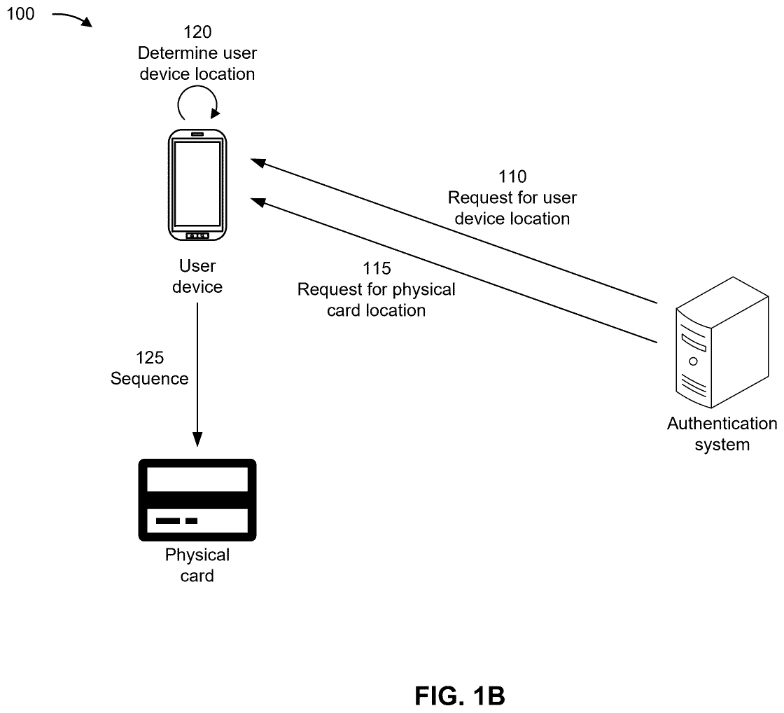

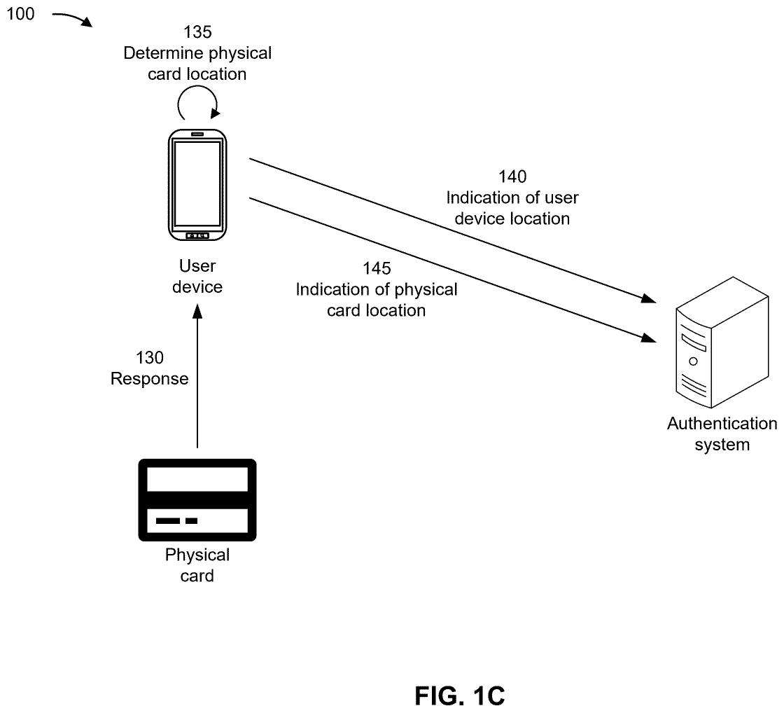

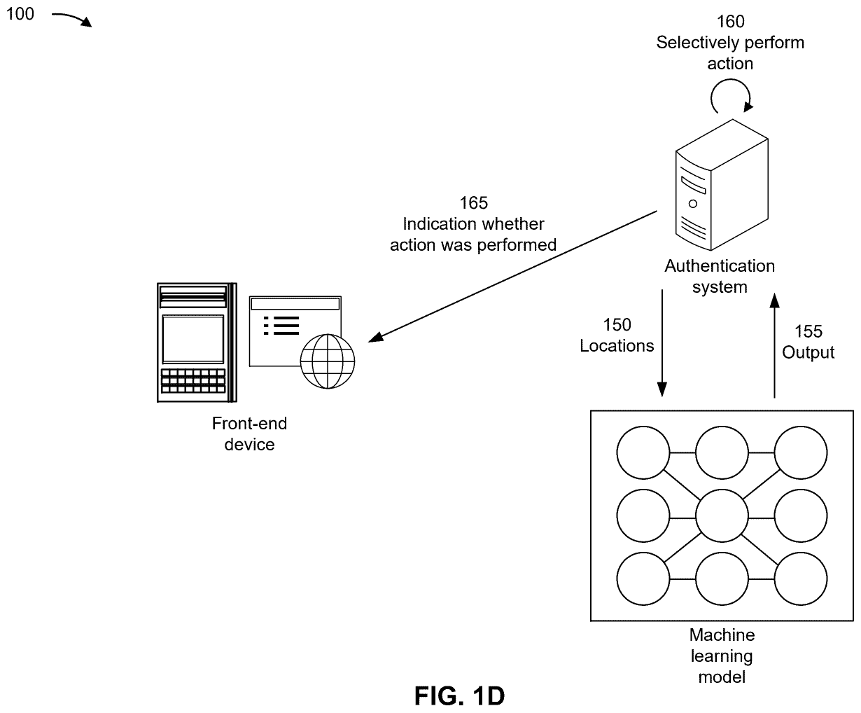

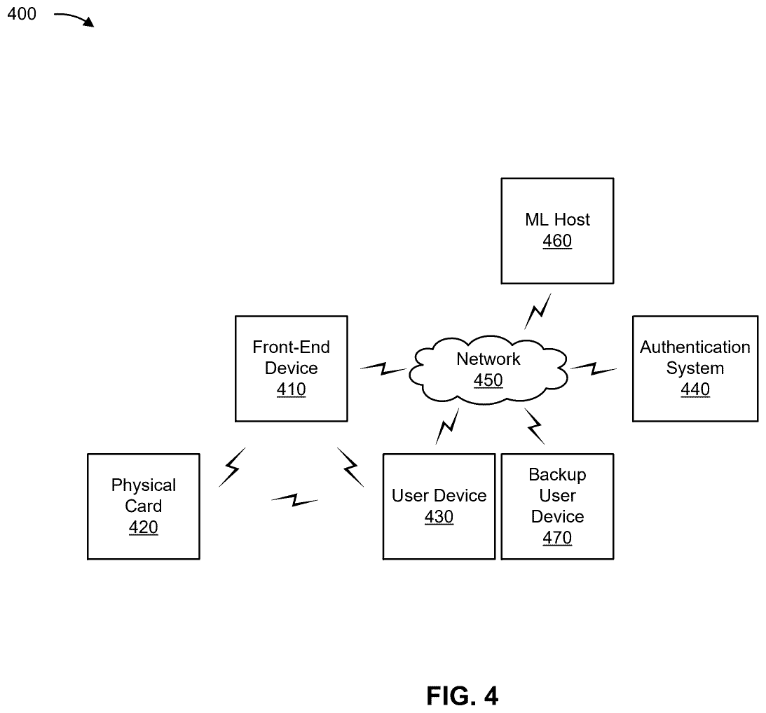

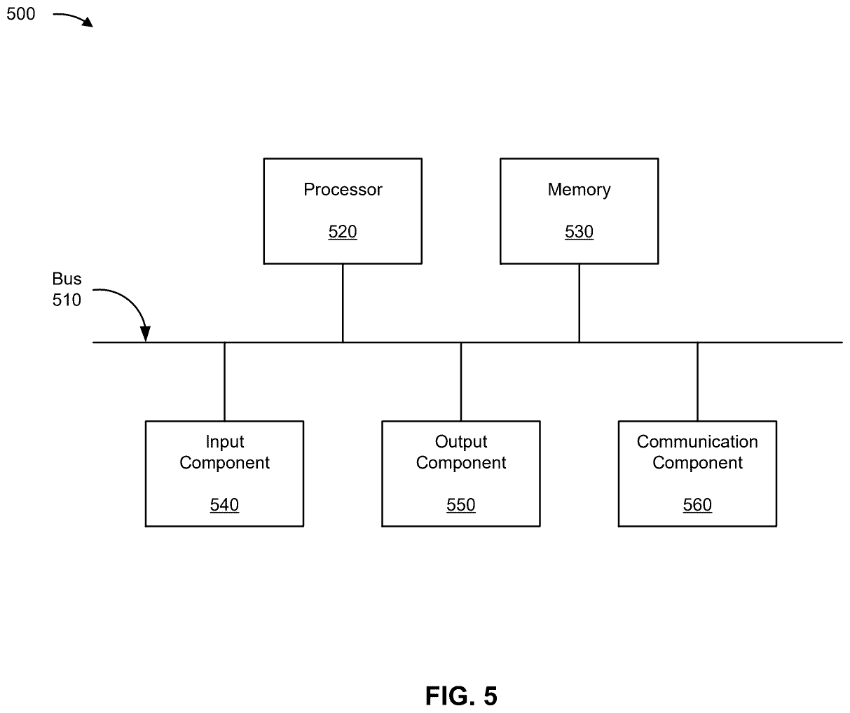

FIGS. 1A-1D are diagrams of an example 100 associated with authentication based on multiple locations. As shown in FIGS. 1A-1D, example 100 includes a front-end device, an authentication system, a user device, a physical card, and a machine learning (ML) model (e.g., provided by an ML host). These devices are described in more detail in connection with FIGS. 4 and 5.

As shown in FIG. 1A and by reference number 105, the front-end device may transmit, and the authentication system may receive, a request to perform an action associated with an account. The action may include verifying an identity of a user requesting permission to access an access-controlled entry, performing a balance inquiry on an account of a user, performing a withdrawal from an account of a user, performing a deposit to an account of a user, or performing a transaction using an account of a user, among other examples. For example, the front-end device may receive input from the user (e.g., using an input component associated with the front-end device, such as a keyboard, a mouse, or a touchscreen, among other examples) that triggers the front-end device to transmit the request. Accordingly, the front-end device may generate the request based on the input. Alternatively, the front-end device may transmit the request periodically (e.g., according to a schedule, whether a default schedule or a schedule configured by the user of the front-end device).

The front-end device may address the request to an Internet protocol (IP) address, a medium access control (MAC) address, and/or another type of identifier associated with the authentication system. In some implementations, the request may include a hypertext transfer protocol (HTTP) request, a file transfer protocol (FTP) request, or another type of web request. Additionally, or alternatively, the front-end device may perform a call to an application programming interface (API) function associated with the authentication system such that the call to the API function comprises the request. The front-end device may include an identifier of the account (e.g., an account number, an account name, and/or another type of identifier associated with the account) in the request (e.g., in a header of the web request and/or as an argument in the call to the API function).

The authentication system may determine a location associated with the request. The location may be represented by an address, a geographic zone (e.g., based on an IP address associated with the request), a set of coordinates (e.g., using a geographic coordinate system (GCS) or another type of coordinate system), or another type of location indicator. The authentication system may determine the location based on an IP address included in the request or based on an address of an entity (e.g., a retailer using the front-end device) associated with the request, among other examples.

As shown in FIG. 1B and by reference number 110, the authentication system may transmit, and the user device may receive, a first location request for a location associated with the user device. The user device may be connected to the account. For example, the authentication system may use a data structure, that associates identifiers of accounts (e.g., account numbers and/or account names, among other examples) with identifiers of user devices (e.g., IP addresses, MAC addresses, and/or device names, among other examples), in order to determine the user device to which to transmit the first location request. The authentication system may maintain the data structure based on input from users. For example, users may indicate which user devices are associated with accounts of the users, and the authentication system may update the data structure accordingly.

Additionally, as shown by reference number 115, the authentication system may transmit, and the user device may receive, a second location request for a location associated with the physical card. The physical card may be connected to the account. Similarly as for the first location request, the authentication system may use the data structure, that associates identifiers of accounts with identifiers of user devices, in order to determine the user device to which to transmit the second location request.

Although the example 100 is described in connection with the first location request being separate from the second location request, other examples may include the authentication system transmitting a single request to the user device that asks for both the location associated with the user device and the location associated with the physical card. Whether the first location request and the second location request are transmitted separately or together, a background application executed by the user device may receive and process the requests. For example, the user of the user device may have instructed the user device to install the background application. Additionally, the user may have authorized an operating system (OS) of the user device to allow the background application to respond to requests from the authentication system even while the user device is sleeping or otherwise in a low-power mode. As a result, latency in approving (or disapproving) the action, as described below in connection with reference number 160, is reduced because the user device may respond to the requests without input from the user.

As shown by reference number 120, the user device may determine the location associated with the user device. For example, the user device may use a driver (e.g., to a global positioning system (GPS) unit or another type of global navigation satellite system (GNSS) unit), controlled by the OS of the user device, in order to determine the location associated with the user device. Accordingly, the user device may determine coordinates associated with the user device. In another example, the user device may use a WiFi signal (or another type of wireless local area network (WLAN) signal) to estimate the location of the user device. The user device may determine a geographic zone based on an IP address assigned to the user device and/or calculate a distance from a router in the WLAN (e.g., using time-of-flight and/or another distance formula), such that the location associated with the user device is the geographic zone and/or a relative location based on the router. In yet another example, the user device may communicate with a location management function (LMF) (or a similar cellular function) to determine the location associated with the user device. Accordingly, the location associated with the user device may be determined within a cellular network.

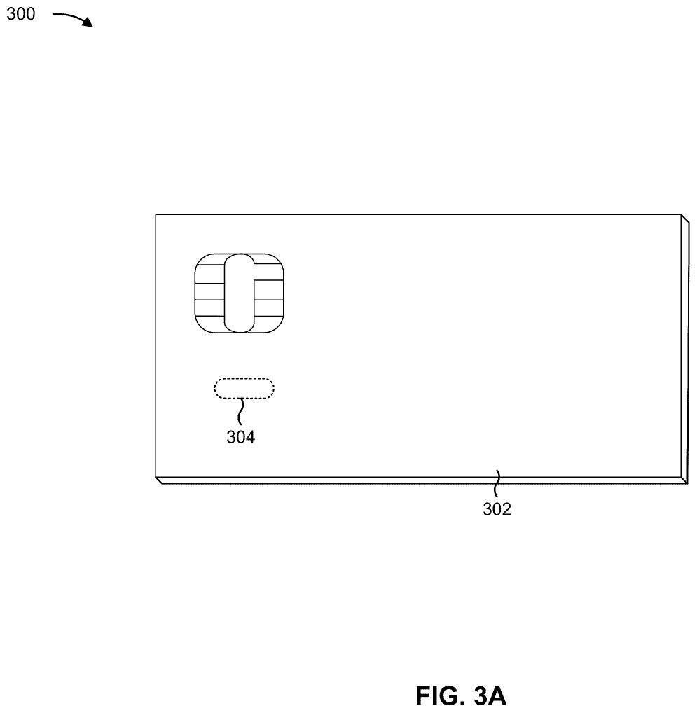

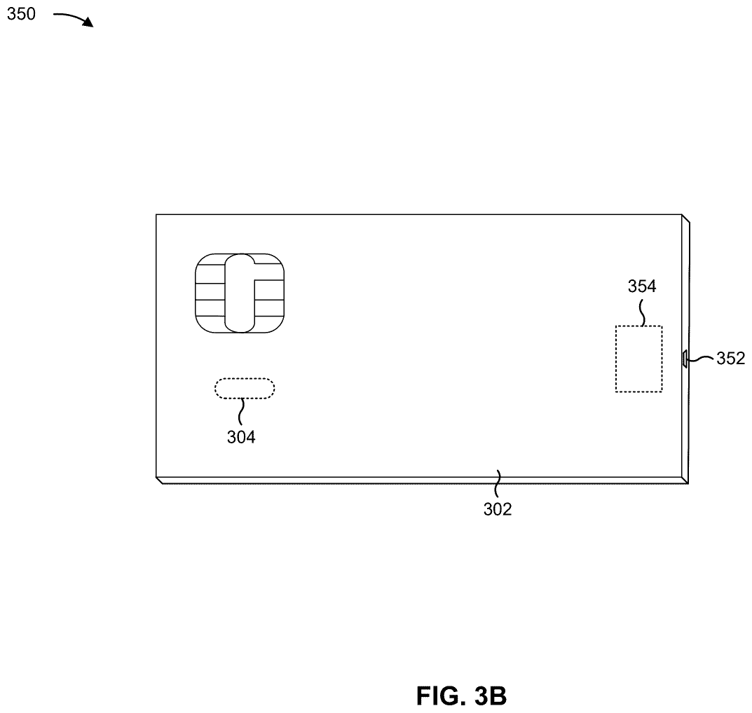

Additionally, the user device may determine the location associated with the physical card. As shown by reference number 125, the user device may transmit a sequence, using short-range electromagnetic waves, to the physical card. As used herein, “short-range” may refer to a signal with an effective distance of 150 meters or less. Effective distance may be determined based on probability (e.g., as a maximum distance at which a receiving device will respond to the short-range signal with a probability that satisfies a reliability threshold) and/or based on energy (e.g., as a distance at which the short-range signal retains at least 40% of its original transmit energy). By selecting a threshold of no more than 150 meters, the physical card may be able to respond to the user device without an independent power source (e.g., as described in connection with FIG. 3A). However, other implementations may use electromagnetic waves with a larger range (e.g., when the physical card includes a battery or another type of independent power source, as described in connection with FIG. 3B).

As shown in FIG. 1C and by reference number 130, the physical card may transmit a response, to the user device, based on the sequence. For example, the physical card may include a coil or an antenna (among other examples) that is configured to energize based on the short-range electromagnetic signal and a memory device that is configured to provide information to encode as the response. Therefore, the coil or the antenna may transmit the response using remaining energy after decoding the sequence and retrieving the information from the memory device. Accordingly, the physical card may function as a radio-frequency identification (RFID) device (e.g., according to International Organization for Standardization (ISO) and International Electrotechnical Commission (IEC) standard 18000 (ISO/IEC 18000)). Alternatively, the physical card may function as a near field communication (NFC) contactless card (e.g., according to ISO/IEC 14443). In another example, the physical card may be an active tag that energizes the coil or the antenna for transmitting the response separately from the power provided by receiving the sequence from the user device.

Accordingly, the user device may monitor for the response. For example, the user device may monitor one or more frequencies (e.g., in which the response from the physical card is expected) for a window of time. The window of time may be preconfigured (e.g., based on how long the physical card takes to respond along with an expected time-of-flight for the sequence and the response at a maximum range, optionally with a margin of error added). Alternatively, the window of time may be dynamic. For example, the user device may estimate channel conditions (e.g., based on communications with other devices such as routers and cell towers) and increase or decrease the window of time based on the channel conditions (e.g., increasing the window of time based on low reference signal received power (RSRP) or other indications of blockages and/or high interference, and decreasing the window of time based on high RSRP or other indications of good line-of-sight and/or low interference).

As shown by reference number 135, the user device may determine the location associated with the physical card based on the response. In one example, the user device may determine the location associated with the physical card based on a time-of-flight associated with the sequence and/or the response. The user device may calculate a distance between the user device and the physical card based on how much time elapsed between transmission of the sequence and reception of the response (e.g., incorporating an amount of time for the user device to transmit the sequence, an amount of time for the physical card to process the sequence and transmit the response, and an amount of time for the user device to decode the response). Accordingly, the location associated with the physical card may be relative to the location associated with the user device (e.g., a distance between the user device and the physical card). In another example, the user device may determine a direction associated with the response and may calculate a vector from the user device to the physical card (e.g., based on the distance between the user device and the physical card, and the direction associated with the response). Therefore, the user device may determine coordinates associated with the physical card by applying the vector to coordinates associated with the user device.

As shown by reference number 140, the user device may transmit, and the authentication system may receive, an indication of the location associated with the user device. The user device may transmit, and the authentication system may receive, the indication in response to the first location request. The indication may include an address, a geographic zone, a set of coordinates, and/or another type of indication of the location associated with the user device. The user device may transmit the indication of the location associated with the user device based on a permission from the OS. For example, the user may have authorized the OS of the user device to allow the authentication system to receive location information. As a result, latency in approving (or disapproving) the action, as described below in connection with reference number 160, is reduced because the user device may transmit the indication of the location associated with the user device without input from the user.

As shown by reference number 145, the user device may transmit, and the authentication system may receive, an indication of the location associated with the physical card. The user device may transmit, and the authentication system may receive, the indication in response to the second location request. In some implementations, the indication of the location associated with the physical card may include a binary variable indicating whether a distance between the user device and the physical card satisfies a threshold. For example, a value of ‘0’ or FALSE may indicate that the distance failed to satisfy the threshold (or that the user device did not detect the response within the window of time in which the user device was monitoring). Correspondingly, a value of ‘1’ or TRUE may indicate that the distance satisfies the threshold. Additionally, or alternatively, the indication of the location associated with the physical card may include a value of a distance between the user device and the physical card. For example, as described above, the user device may calculate the distance (e.g., based on time-of-flight or another type of measurement associated with the sequence and/or the response) and indicate the distance to the authentication system.

As shown in FIG. 1D and by reference number 150, the authentication system may provide the location associated with the request, the location associated with the user device, and/or the location associated with the physical card, to the ML model. For example, the connecting system may transmit, and the ML host may receive, a request including indications of the locations.

The ML model may be trained (e.g., by the ML host and/or a device at least partially separate from the ML host) using a labeled set of locations (e.g., for supervised learning). Additionally, or alternatively, the ML model may be trained using an unlabeled set of locations (e.g., for deep learning). The ML model may be configured to determine whether the action should be performed or not (e.g., based on the locations). Additionally, or alternatively, the ML model may be configured to generate a risk score (e.g., based on the locations). For example, the ML model may determine a probability that the action is fraudulent (e.g., based on the locations). Accordingly, the action may be performed (or not) based on whether the risk score satisfies a fraud threshold.

In some implementations, the ML model may include a regression algorithm (e.g., linear regression or logistic regression), which may include a regularized regression algorithm (e.g., Lasso regression, Ridge regression, or Elastic-Net regression). Additionally, or alternatively, the ML model may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., information about front-end devices). For example, for a regression algorithm, a model parameter may include a regression coefficient (e.g., a weight). For a decision tree algorithm, a model parameter may include a decision tree split location, as an example.

Additionally, the ML host (and/or a device at least partially separate from the ML host) may use one or more hyperparameter sets to tune the ML model. A hyperparameter may include a structural parameter that controls execution of a machine learning algorithm by the authentication system, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

As shown by reference number 155, the authentication system may receive output from the ML model (e.g., from the ML host). For example, the output may include a binary variable indicating whether the authentication system should perform the action (indicated in the request, as described in connection with FIG. 1A). In another example, the output may include a risk score (e.g., a probability or another type of quantitative or qualitative score).

As shown by reference number 160, the authentication system may selectively perform the action based on the output from the machine learning model. For example, the selectivity may map to a binary variable included in the output. In other words, the authentication system may perform the action based on the output including a positive variable (e.g., with a value of ‘1’ or ‘TRUE’) and may refrain from performing the action based on the output including a negative variable (e.g., with a value of ‘0’ or ‘FALSE’). In another example, the selectivity may be based on a fraud threshold. In other words, the authentication system may perform the action based on the output (e.g., including a risk score) satisfying the fraud threshold, and may refrain from performing the action based on the output (e.g., including the risk score) failing to satisfy the fraud threshold.

Although the example 100 is described in connection with the authentication system selectively performing the action based on the output from the ML model, other examples may include the authentication system selectively performing the action based on a set of rules. For example, the set of rules may include a rule that a first distance, between the location associated with the physical card and the location associated with the user device, ought to satisfy a first threshold. In other words, the set of rules may verify that the physical card is sufficiently close to the user device. In another example, the set of rules may include a rule that a second distance, between the location associated with the request and the location associated with the user device, ought to satisfy a second threshold. In other words, the set of rules may verify that the physical card is sufficiently close to the request. The selectivity may be based on the set of rules connected with Boolean operators. For example, the authentication system may perform the action based on the first distance satisfying the first threshold and based on the second distance satisfying the second threshold. In another example, the authentication system may refrain from performing the action based on the first distance failing to satisfy the first threshold or based on the second distance failing to satisfy the second threshold. Other examples may include additional and/or alternative rules for selectively performing the action based on the locations.

As shown by reference number 165, the authentication system may transmit, and the front-end device may receive, an indication of whether the action was performed. For example, the authentication system may indicate whether a transaction was performed, whether an identity of the user was verified, whether a withdrawal was approved, or whether a deposit was accepted, among other examples. In some implementations, the front-end device may output an indication to the user of the front-end device. For example, the front-end device may use an output component (e.g., a screen or a speaker, among other examples) to inform the user whether the action was performed. Additionally, or alternatively, the front-end device may perform an operation based on the indication of whether the action was performed. For example, the authentication system may approve a withdrawal such that the front-end device dispenses money to the user. In another example, the authentication system may verify an identity of the user such that the front-end device provides the user with permission to access an access-controlled entry (e.g., by lifting a gate, unlocking a door, or activating an elevator, among other examples).

By using techniques as described in connection with FIGS. 1A-1D, the authentication system may verify that the physical card is near the location associated with the request before performing the action indicated by the request (e.g., using the account). As a result, chances of fraud based on stealing the physical card are reduced, which conserves power and processing resources that otherwise would have been wasted in performing an action not authorized by a user (of the account) and in undoing the action later (e.g., after the fraud is discovered).

As indicated above, FIGS. 1A-1D are provided as an example. Other examples may differ from what is described with regard to FIGS. 1A-1D.

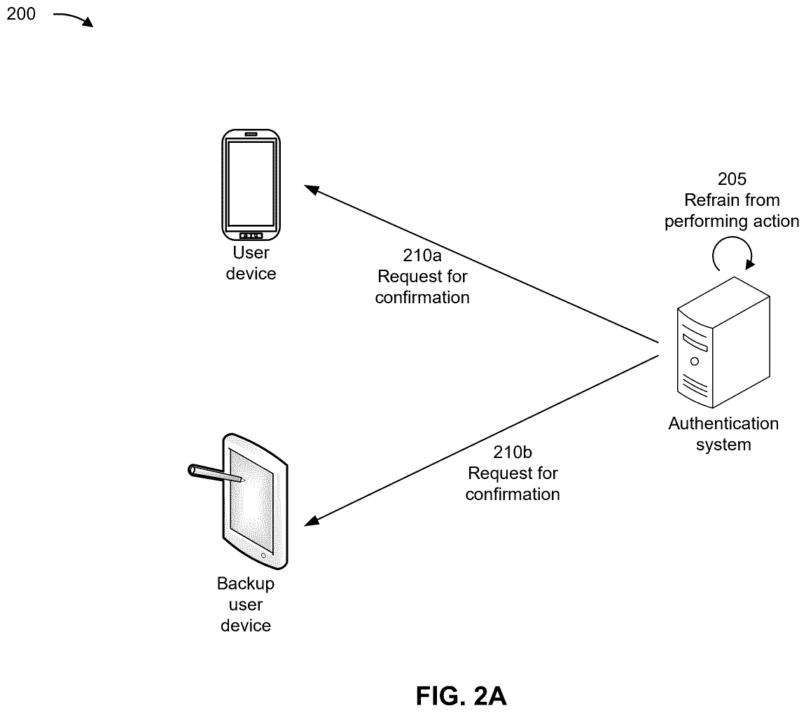

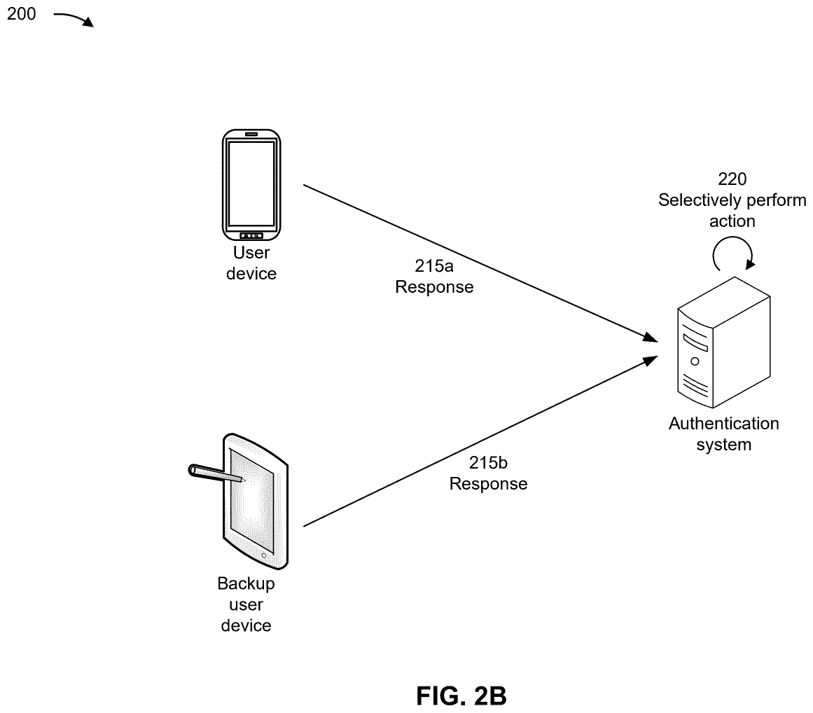

FIGS. 2A-2B are diagrams of an example 200 associated with overriding authentication based on multiple locations. As shown in FIGS. 2A-2B, example 200 includes an authentication system, a user device, and a backup user device. These devices are described in more detail in connection with FIGS. 4 and 5.

In the example 200, the authentication system may have received a request to perform an action associated with an account, as described in connection with FIG. 1A. Additionally, the authentication system may use a location associated with the request, a location associated with the user device, and/or a location associated with a physical card, to determine whether to perform the action, as described in connection with FIG. 1D. As shown in FIG. 2A and by reference number 205, the authentication system may refrain from performing the action. For example, the location associated with the request, the location associated with the user device, and/or the location associated with a physical card may have failed to satisfy a condition. The condition may include a condition that a distance, between the location associated with the physical card and the location associated with the user device, satisfies a threshold, as described in connection with FIG. 1D.

As shown by reference number 210a, the authentication system may transmit, and the user device may receive, a request for confirmation. The authentication system may transmit, and the user device may receive, the request based on the location(s) failing to satisfy the condition. The authentication system may use a data structure, that associates identifiers of accounts (e.g., account numbers and/or account names, among other examples) with identifiers of user devices (e.g., IP addresses, MAC addresses, and/or device names, among other examples), in order to determine the user device to which to transmit the request for confirmation. The authentication system may maintain the data structure based on input from users. For example, users may indicate which user devices are associated with accounts of the users, and the authentication system may update the data structure accordingly.

The request for confirmation may include a secret code. For example, the request for confirmation may initiate a two-factor authentication (2FA) process. Alternatively, the user may have established a secret code associated with the account (e.g., similar to a personal identification number (PIN)). Accordingly, the request for confirmation may include a prompt for the secret code.

Additionally, or alternatively, as shown by reference number 210b, the authentication system may transmit, and the backup user device may receive, a request for confirmation. The authentication system may transmit, and the backup user device may receive, the request based on the location(s) failing to satisfy the condition. The authentication system may use a data structure, that associates identifiers of accounts (e.g., account numbers and/or account names, among other examples) with identifiers of backup user devices (e.g., IP addresses, MAC addresses, and/or device names, among other examples), in order to determine the backup user device to which to transmit the request for confirmation. The authentication system may maintain the data structure based on input from users. For example, users may register backup user devices for their accounts, and the authentication system may update the data structure accordingly. As described above, the request for confirmation may include a secret code or may include a prompt for a (pre-established) secret code (associated with the account).

As shown in FIG. 2B and by reference number 215a, the user device may transmit, and the authentication system may receive, a response to the request for confirmation. For example, the user may input a secret code into the user device, and the user device may indicate the secret code in the response. Accordingly, the authentication system may complete the 2FA process. Alternatively, the authentication system may attempt to validate the secret code, indicated in the response, with a (pre-established) secret code stored in association with the account.

Additionally, or alternatively, as shown by reference number 215b, the backup user device may transmit, and the authentication system may receive, a response to the request for confirmation. For example, the user may input a secret code into the backup user device, and the backup user device may indicate the secret code in the response. Accordingly, the authentication system may complete the 2FA process. Alternatively, the authentication system may attempt to validate the secret code, indicated in the response, with a (pre-established) secret code stored in association with the account.

As shown by reference number 220, the authentication system may selectively perform the action based on the response. For example, the authentication system may perform the action in response to the secret code, indicated in the response, matching the secret code transmitted by the authentication system. On the other hand, the authentication system may refrain from performing the action in response to the secret code, indicated in the response, failing to match the secret code transmitted by the authentication system. In another example, the authentication system may perform the action in response to the secret code, indicated in the response, matching the secret code stored in association with the account. On the other hand, the authentication system may refrain from performing the action in response to the secret code, indicated in the response, failing to match the secret code stored in association with the account.

By using techniques as described in connection with FIGS. 2A-2B, the authentication system may perform the action even when the physical card is not near the location associated with the request and/or the location associated with the user device. As a result, the authentication system conserves power and processing resources that otherwise would have been wasted in refusing to perform the action because the action was indeed authorized by a user (of the account) and would otherwise have to be performed later (e.g., after the user moved the user device closer to the physical card).

As indicated above, FIGS. 2A-2B are provided as an example. Other examples may differ from what is described with regard to FIGS. 2A-2B.

FIGS. 3A and 3B are diagrams of an example physical card 300 and an example physical card 350, respectively. Physical cards are described in more detail in connection with FIG. 4.

As shown in FIG. 3A, the example physical card 300 may include a substrate 302. The substrate 302 may include a metal (e.g., a single metal or an alloy), a plastic (e.g., a single plastic or a composite), and/or another type of solid material into which electrical components may be embedded. For example, the substrate may include a hollow cavity or other void into which electrical components are inserted. Accordingly, the substrate may include at least two portions of material that are adhered (e.g., using a glue or other adhesive), melded, or otherwise fused together to enclose the electrical components therein. Additionally, or alternatively, the substrate may be molded or otherwise formed around the electrical components in order to embed the electrical components therein. In some implementations, physical properties of the substrate 302 may be consistent with ISO/IEC 7810, ISO/IEC 14443-1, and/or ISO/IEC 7816-1. For example, the substrate 302 may have a width in a range from 15 millimeters (mm) (approximately 0.591 inches (in.)) to 88 mm (approximately 3.465 in.). Additionally, the substrate 302 may have a length in a range from 25 mm (approximately 0.984 in.) to 125 mm (approximately 4.921 in.). The substrate 302 may have a height in a range from 0.68 mm (approximately 0.027 in.) to 0.84 mm (approximately 0.033 in.).

The example physical card 300 may further include a transceiver 304. For example, the transceiver 304 may include a coil, an antenna, and/or another type of device that receives and transmits electromagnetic signals over-the-air (OTA) (e.g., wirelessly). As described in connection with FIG. 1B, the transceiver 304 may receive a sequence from a user device. Additionally, as described in connection with FIG. 1C, the transceiver 304 may transmit a response. For example, the response may be encoded in a memory that is at least partially integrated with the transceiver 304, as shown in FIG. 3A. Other examples may include a separate memory that is connected to the transceiver 304 via one or more buses. In some implementations, as further shown in FIG. 3A, the transceiver 304 may be at least partially embedded in the substrate 302.

As shown in FIG. 3B, the example physical card 350 may include a substrate 302 and a transceiver 304, as described in connection with FIG. 3A. Additionally, as shown in FIG. 3B, the example physical card 350 may include a power source 354. For example, the power source 354 may be a battery or another type of device that stores electrical potential. The power source 354 provides power for the transceiver 304. Accordingly, the power source 354 may have at least one wired connection with the transceiver 304. As further shown in FIG. 3B, the power source 354 may be at least partially embedded in the substrate 302.

In some implementations, the example physical card 350 may include a port 352 (e.g., a universal serial bus (USB) port or another type of port) for charging the power source 354. The port 352 may be at least partially embedded on an edge of the substrate 302. Accordingly, the port 352 may be configured to transfer electricity from an external power source to the power source 354. In some implementations, the example physical card 350 may further include a transformer and/or similar circuits (not shown) configured to manage a flow of direct current into the power source 354 (e.g., to prevent over-charging the power source 354).

Additionally, or alternatively, the example physical card 350 may include a motion device for converting kinetic energy into electrical energy to charge the power source 354. Other implementations may include a solar converter for converting sunlight into electrical energy to charge the power source 354 or a radio frequency (RF) device for converting electromagnetic signals into electrical energy to charge the power source 354.

As indicated above, FIGS. 3A-3B are provided as examples. Other examples may differ from what is described with regard to FIGS. 3A-3B.

FIG. 4 is a diagram of an example environment 400 in which systems and/or methods described herein may be implemented. As shown in FIG. 4, environment 400 may include a front-end device 410, a physical card 420, a user device 430, an authentication system 440, a network 450, an ML host 460, and/or a backup user device 470. Devices of environment 400 may interconnect via wired connections and/or wireless connections.

The front-end device 410 may include one or more devices capable of facilitating an electronic transaction. For example, the front-end device 410 may include a PoS terminal, a payment terminal (e.g., a credit card terminal, a contactless payment terminal, a mobile credit card reader, or a chip reader), and/or an automated teller machine (ATM). In some implementations, the front-end device 410 may include an access control terminal (e.g., used to control physical access to a secure area), such as an access control panel used to control an access-controlled entry (e.g., a turnstile, a door, a gate, or another physical barrier). The front-end device 410 may include one or more input components and/or one or more output components to facilitate obtaining data (e.g., account information) from the physical card 420 and/or to facilitate interaction with and/or authorization from an owner or accountholder of the physical card 420. Example input components of the front-end device 410 include a number keypad, a touchscreen, a magnetic stripe reader, a chip reader, and/or an RF signal reader (e.g., an NFC reader). Example output devices of front-end device 410 include a display and/or a speaker.

The physical card 420 may include one or more devices capable of being used for an electronic transaction. In some implementations, the physical card 420 may include a transaction card (or another physical medium with integrated circuitry) capable of storing and communicating account information, such as a credit card, a debit card, a gift card, an ATM card, a transit card, a fare card, and/or an access card.

The physical card 420 may store account information, which may be used in connection with an electronic transaction facilitated by the front-end device 410. The account information may include, for example, an account identifier that identifies an account (e.g., a bank account or a credit account) associated with the physical card 420 (e.g., an account number, a card number, a bank routing number, and/or a bank identifier), a cardholder identifier (e.g., identifying a name of a person, business, or entity associated with the account or the physical card 420), expiration information (e.g., identifying an expiration month and/or an expiration year associated with the physical card 420), and/or a credential (e.g., a payment token). In some implementations, the physical card 420 may store the account information in tamper-resistant memory of the physical card 420, such as in a secure element. As part of performing an electronic transaction, the physical card 420 may transmit the account information to the front-end device 410 using a communication component, such as a magnetic stripe, an integrated circuit (IC) chip (e.g., a EUROPAY®, MASTERCARD®, VISA® (EMV) chip), and/or a contactless communication component (e.g., an NFC component, an RF component, a Bluetooth® component, and/or a Bluetooth Low Energy (BLE) component). Thus, the physical card 420 and the front-end device 410 may communicate with one another by coming into contact with one another (e.g., using a magnetic stripe or an EMV chip) or via contactless communication (e.g., using NFC).

The user device 430 may include one or more devices capable of being used for an electronic transaction. The user device 430 may include a communication device and/or a computing device. For example, the user device 430 may include a wireless communication device, a mobile phone, a user equipment, a tablet computer, a wearable communication device (e.g., a smart wristwatch, a pair of smart eyeglasses, a head mounted display, or a virtual reality headset), or a similar type of device. Additionally, or alternatively, the user device 430 may be capable of receiving, generating, storing, processing, and/or providing information associated with locations, as described elsewhere herein.

The authentication system 440 may include one or more devices capable of processing, authorizing, and/or facilitating a transaction. For example, the authentication system 440 may include one or more servers and/or computing hardware (e.g., in a cloud computing environment or separate from a cloud computing environment) configured to receive and/or store information associated with processing an electronic transaction. The authentication system 440 may process a transaction, such as to approve (e.g., permit, authorize, or the like) or decline (e.g., reject, deny, or the like) the transaction and/or to complete the transaction if the transaction is approved. The authentication system 440 may process the transaction based on information received from the front-end device 410, such as transaction data (e.g., information that identifies a transaction amount, a merchant, a time of a transaction, a location of the transaction, or the like), account information communicated to the front-end device 410 (e.g., by the physical card 420), and/or information stored by the authentication system 440 (e.g., for fraud detection).

The authentication system 440 may be associated with a financial institution (e.g., a bank, a lender, a credit card company, or a credit union) and/or may be associated with a transaction card association that authorizes a transaction and/or facilitates a transfer of funds. For example, the authentication system 440 may be associated with an issuing bank associated with the physical card 420, an acquiring bank (or merchant bank) associated with the merchant and/or the front-end device 410, and/or a transaction card association (e.g., VISA or MASTERCARD) associated with the physical card 420. Based on receiving information associated with the physical card 420 from the front-end device 410, one or more devices of the authentication system 440 may communicate to authorize a transaction and/or to transfer funds from an account associated with the physical card 420 to an account of an entity (e.g., a merchant) associated with the front-end device 410.

The network 450 may include one or more wired and/or wireless networks. For example, the network 450 may include a cellular network, a public land mobile network, a local area network, a wide area network, a metropolitan area network, a telephone network, a private network, the Internet, and/or a combination of these or other types of networks. The network 450 enables communication among the devices of environment 400. In some implementations, the front-end device 410 may communicate with the physical card 420 using a first network (e.g., a contactless network or by coming into contact with the physical card 420) and may communicate with the authentication system 440 using a second network.

The ML host 460 may include one or more devices capable of receiving, generating, storing, processing, and/or providing information associated with machine learning models, as described elsewhere herein. The ML host 460 may include a communication device and/or a computing device. For example, the ML host 460 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device.

The backup user device 470 may include one or more devices capable of being used for an electronic transaction. The backup user device 470 may include a communication device and/or a computing device. For example, the backup user device 470 may include a wireless communication device, a mobile phone, a user equipment, a tablet computer, a wearable communication device (e.g., a smart wristwatch, a pair of smart eyeglasses, a head mounted display, or a virtual reality headset), or a similar type of device. Additionally, or alternatively, the backup user device 470 may be capable of receiving, generating, storing, processing, and/or providing information associated with secret codes, as described elsewhere herein.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500 associated with authentication based on multiple locations. The device 500 may correspond to a front-end device 410, a physical card 420, a user device 430, an authentication system 440, an ML host 460, and/or a backup user device 470. In some implementations, a front-end device 410, a physical card 420, a user device 430, an authentication system 440, an ML host 460, and/or a backup user device 470 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

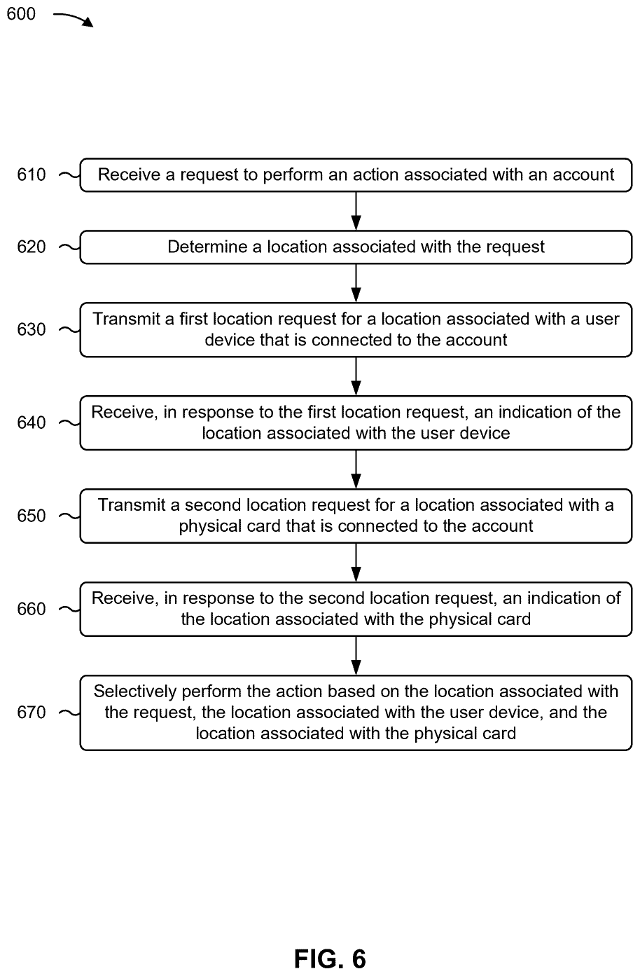

FIG. 6 is a flowchart of an example process 600 associated with authentication based on multiple locations. In some implementations, one or more process blocks of FIG. 6 may be performed by an authentication system 440. In some implementations, one or more process blocks of FIG. 6 may be performed by another device or a group of devices separate from or including the authentication system 440, such as a front-end device 410, a physical card 420, a user device 430, an ML host 460, and/or a backup user device 470. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include receiving a request to perform an action associated with an account (block 610). For example, the authentication system 440 (e.g., using processor 520, memory 530, input component 540, and/or communication component 560) may receive a request to perform an action associated with an account, as described above in connection with reference number 105 of FIG. 1A. As an example, the action may include verifying the account in order to provide permission to access an access-controlled entry, performing a balance inquiry on the account, performing a withdrawal from the account, performing a deposit to the account, or performing a transaction using the account, among other examples.

As further shown in FIG. 6, process 600 may include determining a location associated with the request (block 620). For example, the authentication system 440 (e.g., using processor 520 and/or memory 530) may determine a location associated with the request, as described above in connection with FIG. 1A. As an example, the authentication system 440 may determine the location based on an IP address included in the request or based on an address of an entity (e.g., a retailer using a front-end device) associated with the request, among other examples.

As further shown in FIG. 6, process 600 may include transmitting a first location request for a location associated with a user device that is connected to the account (block 630). For example, the authentication system 440 (e.g., using processor 520, memory 530, and/or communication component 560) may transmit a first location request for a location associated with a user device that is connected to the account, as described above in connection with reference number 110 of FIG. 1B. As an example, the authentication system 440 may use a data structure, that associates identifiers of accounts (e.g., account numbers and/or account names, among other examples) with identifiers of user devices (e.g., IP addresses, MAC addresses, and/or device names, among other examples), in order to determine the user device to which to transmit the first location request.

As further shown in FIG. 6, process 600 may include receiving, in response to the first location request, an indication of the location associated with the user device (block 640). For example, the authentication system 440 (e.g., using processor 520, memory 530, and/or communication component 560) may receive, in response to the first location request, an indication of the location associated with the user device, as described above in connection with reference number 140 of FIG. 1C. As an example, the indication may include an address, a geographic zone, a set of coordinates, and/or another type of indication of the location associated with the user device.

As further shown in FIG. 6, process 600 may include transmitting a second location request for a location associated with a physical card that is connected to the account (block 650). For example, the authentication system 440 (e.g., using processor 520, memory 530, and/or communication component 560) may transmit a second location request for a location associated with a physical card that is connected to the account, as described above in connection with reference number 115 of FIG. 1B. As an example, the authentication system 440 may use a data structure, that associates identifiers of accounts (e.g., account numbers and/or account names, among other examples) with identifiers of user devices (e.g., IP addresses, MAC addresses, and/or device names, among other examples), in order to determine the user device to which to transmit the second location request.

As further shown in FIG. 6, process 600 may include receiving, in response to the second location request, an indication of the location associated with the physical card (block 660). For example, the authentication system 440 (e.g., using processor 520, memory 530, and/or communication component 560) may receive, in response to the second location request, an indication of the location associated with the physical card, as described above in connection with reference number 145 of FIG. 1C. As an example, the indication of the location associated with the physical card may include a binary variable indicating whether a distance between the user device and the physical card satisfies a threshold. Additionally, or alternatively, the indication of the location associated with the physical card may include a value of a distance between the user device and the physical card.

As further shown in FIG. 6, process 600 may include selectively performing the action based on the location associated with the request, the location associated with the user device, and the location associated with the physical card (block 670). For example, the authentication system 440 (e.g., using processor 520 and/or memory 530) may selectively perform the action based on the location associated with the request, the location associated with the user device, and the location associated with the physical card, as described above in connection with reference number 160 of FIG. 1D. As an example, the authentication system 440 may selectively perform the action based on output from a machine learning model (e.g., in response to input, to the machine learning model, that includes the locations). Additionally, or alternatively, the authentication system 440 may selectively perform the action based on a set of rules (e.g., applied to the locations).

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1D, 2A-2B, and/or 3A-3B. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

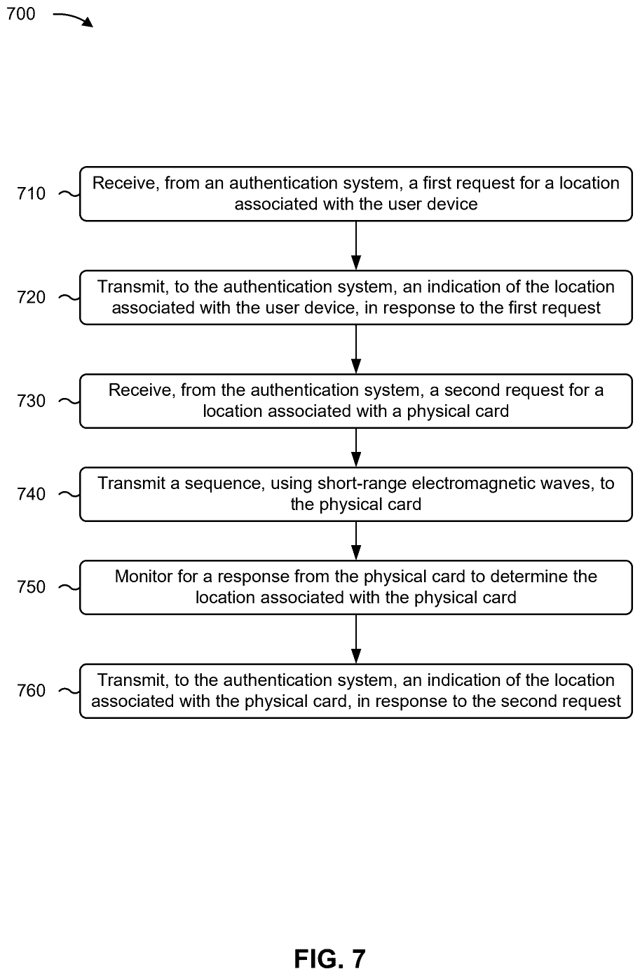

FIG. 7 is a flowchart of an example process 700 associated with authentication based on multiple locations. In some implementations, one or more process blocks of FIG. 7 may be performed by a user device 430. In some implementations, one or more process blocks of FIG. 7 may be performed by another device or a group of devices separate from or including the user device 430, such as a front-end device 410, a physical card 420, an authentication system 440, an ML host 460, and/or a backup user device 470. Additionally, or alternatively, one or more process blocks of FIG. 7 may be performed by one or more components of the device 500, such as processor 520, memory 530, input component 540, output component 550, and/or communication component 560.

As shown in FIG. 7, process 700 may include receiving, from an authentication system, a first request for a location associated with the user device (block 710). For example, the user device 430 (e.g., using processor 520, memory 530, and/or communication component 560) may receive, from an authentication system, a first request for a location associated with the user device, as described above in connection with reference number 110 of FIG. 1B. As an example, a user may have authorized an OS of the user device 430 to allow a background application to receive the first request from the authentication system even while the user device 430 is sleeping or otherwise in a low-power mode.

As further shown in FIG. 7, process 700 may include transmitting, to the authentication system, an indication of the location associated with the user device, in response to the first request (block 720). For example, the user device 430 (e.g., using processor 520, memory 530, and/or communication component 560) may transmit, to the authentication system, an indication of the location associated with the user device, in response to the first request, as described above in connection with reference number 140 of FIG. 1C. As an example, a user may have authorized an OS of the user device 430 to allow the authentication system to receive location information. As a result, the user device 430 may transmit the indication of the location associated with the user device 430 without input from the user.

As further shown in FIG. 7, process 700 may include receiving, from the authentication system, a second request for a location associated with a physical card (block 730). For example, the user device 430 (e.g., using processor 520, memory 530, and/or communication component 560) may receive, from the authentication system, a second request for a location associated with a physical card, as described above in connection with reference number 115 of FIG. 1B. As an example, a user may have authorized an OS of the user device 430 to allow a background application to receive the second request from the authentication system even while the user device 430 is sleeping or otherwise in a low-power mode.

As further shown in FIG. 7, process 700 may include transmitting a sequence, using short-range electromagnetic waves, to the physical card (block 740). For example, the user device 430 (e.g., using processor 520, memory 530, and/or communication component 560) may transmit a sequence, using short-range electromagnetic waves, to the physical card, as described above in connection with reference number 125 of FIG. 1B. As an example, the user device 430 may use short-range electromagnetic waves such that the physical card may respond to the user device 430 without an independent power source. However, other implementations may include the user device 430 using electromagnetic waves with a larger range (e.g., when the physical card includes a battery or another type of independent power source, as described in connection with FIG. 3B).

As further shown in FIG. 7, process 700 may include monitoring for a response from the physical card to determine the location associated with the physical card (block 750). For example, the user device 430 (e.g., using processor 520, memory 530, and/or communication component 560) may monitor for a response from the physical card to determine the location associated with the physical card, as described above in connection with reference number 130 of FIG. 1C. As an example, the user device 430 may monitor one or more frequencies (e.g., in which the response from the physical card is expected) for a window of time. The window of time may be preconfigured or may be dynamic.

As further shown in FIG. 7, process 700 may include transmitting, to the authentication system, an indication of the location associated with the physical card, in response to the second request (block 760). For example, the user device 430 (e.g., using processor 520, memory 530, and/or communication component 560) may transmit, to the authentication system, an indication of the location associated with the physical card, in response to the second request, as described above in connection with reference number 145 of FIG. 1C. As an example, the user device 430 may calculate a distance between the user device 430 and the physical card (e.g., based on time-of-flight or another type of measurement associated with the sequence and/or the response). Accordingly, the indication of the location associated with the physical card may include a binary variable indicating whether the distance satisfies a threshold and/or a value of the distance.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 1A-1D, 2A-2B, and/or 3A-3B. Moreover, while the process 700 has been described in relation to the devices and components of the preceding figures, the process 700 can be performed using alternative, additional, or fewer devices and/or components. Thus, the process 700 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for authentication based on multiple locations, the system comprising:
one or more memories; and
one or more processors, communicatively coupled to the one or more memories, configured to:
receive a request to perform an action associated with an account;
determine a location associated with the request;
transmit a first location request for a location associated with a user device that is connected to the account;
receive, in response to the first location request, an indication of the location associated with the user device;
transmit a second location request for a location associated with a physical card that is connected to the account;
receive, in response to the second location request, an indication of the location associated with the physical card; and
selectively perform the action based on the location associated with the request, the location associated with the user device, and the location associated with the physical card.

2. The system of claim 1, wherein the one or more processors, to determine the location associated with the request, are configured to:
determine the location based on an Internet protocol address included in the request; or
determine the location based on an address of an entity associated with the request.

3. The system of claim 1, wherein the indication of the location associated with the user device comprises coordinates associated with the user device.

4. The system of claim 1, wherein the location associated with the physical card is relative to the location associated with the user device.

5. The system of claim 1, wherein the one or more processors, to selectively perform the action, are configured to:
perform the action based on a first distance, between the location associated with the physical card and the location associated with the user device, satisfying a first threshold, and based on a second distance, between the location associated with the request and the location associated with the user device, satisfying a second threshold.

6. The system of claim 1, wherein the one or more processors, to selectively perform the action, are configured to:
refrain from performing the action based on a first distance, between the location associated with the physical card and the location associated with the user device, failing to satisfy a first threshold, or based on a second distance, between the location associated with the request and the location associated with the user device, failing to satisfy a second threshold.

7. The system of claim 1, wherein the one or more processors, to selectively perform the action, are configured to:
provide the location associated with the request, the location associated with the user device, and the location associated with the physical card, to a machine learning model; and
selectively perform the action based on output from the machine learning model.

8. The system of claim 1, wherein the action comprises a transaction that uses the account.

9. A method of authentication based on multiple locations, comprising:
receiving, at a user device and from an authentication system, a first request for a location associated with the user device;
transmitting, to the authentication system and from the user device, an indication of the location associated with the user device, in response to the first request;
receiving, at the user device and from the authentication system, a second request for a location associated with a physical card;
transmitting a sequence, using short-range electromagnetic waves, from the user device and to the physical card;
monitoring, at the user device, for a response from the physical card to determine the location associated with the physical card; and
transmitting, to the authentication system and from the user device, an indication of the location associated with the physical card, in response to the second request.

10. The method of claim 9, further comprising:
determining the location associated with the user device using a driver controlled by an operating system (OS) of the user device,
wherein the indication of the location associated with the user device is transmitted based on a permission from the OS.

11. The method of claim 9, further comprising:
determining the location associated with the physical card based on a time-of-flight associated with the sequence or the response from the physical card.

12. The method of claim 9, wherein the indication of the location associated with the physical card comprises a binary variable indicating whether a distance between the user device and the physical card satisfies a threshold.

13. The method of claim 9, wherein the indication of the location associated with the physical card comprises a value of a distance between the user device and the physical card.

14. The method of claim 9, wherein the first request and the second request are received by a background application executed by the user device.

15. A non-transitory computer-readable medium storing a set of instructions for authentication based on multiple locations, the set of instructions comprising:
one or more instructions that, when executed by one or more processors of a device, cause the device to:
receive a request to perform an action associated with an account;
determine a location associated with the request;
transmit a first location request for a location associated with a user device that is connected to the account;
receive, in response to the first location request, an indication of the location associated with the user device;
transmit a second location request for a location associated with a physical card that is connected to the account;
receive, in response to the second location request, an indication of the location associated with the physical card;
transmit a request for confirmation based on the location associated with the physical card failing to satisfy a condition;
receive a response to the request for confirmation; and
selectively perform the action based on the response.

16. The non-transitory computer-readable medium of claim 15, wherein the condition comprises a distance, between the location associated with the physical card and the location associated with the user device, satisfying a threshold.

17. The non-transitory computer-readable medium of claim 15, wherein the one or more instructions, that cause the device to transmit the request for confirmation, cause the device to:
transmit, to an additional user device that is connected to the account, a secret code,
wherein the response to the request for confirmation indicates the secret code.

18. The non-transitory computer-readable medium of claim 15, wherein the one or more instructions, that cause the device to transmit the request for confirmation, cause the device to:
transmit, to the user device, a prompt for a secret code associated with the account,
wherein the response to the request for confirmation indicates the secret code.

19. The non-transitory computer-readable medium of claim 15, wherein the one or more instructions, that cause the device to selectively perform the action, cause the device to:
validate a secret code indicated by the response to the request for confirmation; and
perform the action based on the secret code being validated.

20. The non-transitory computer-readable medium of claim 15, wherein the one or more instructions, that cause the device to selectively perform the action, cause the device to:
attempt to validate a secret code indicated by the response to the request for confirmation; and
refrain from performing the action based on the secret code failing to be validated.
